(19) United States
(12) Patent Application Publication
(10) Pub. No.: US 2019/0286841 A1
(43) Pub. Date: Sep. 19, 2019

(54) DETECTING ALTERATIONS OF JOURNAL DATA STRUCTURES

(71) Applicant: Square, Inc., San Francisco, CA (US)

(72) Inventors: Cedric Staub, Oakland, CA (US); Anthony Bishopric, San Francisco, CA (US)

(21) Appl. No.: 15/923,403

(22) Filed: Mar. 16, 2018

(51) Int. Cl. G06F 21/62; G06Q 40/00; H04L 9/30; G06F 21/60

(52) U.S. Cl. CPC G06F 21/6245; G06F 21/602; H04L 9/30; G06Q 40/12

(57) ABSTRACT

Techniques are described for securely managing double-entry account journals provided for use by clients such as businesses and other organizations. Clients may implement their own accounting systems, or other systems that model financial information, which may use the described techniques for maintaining account journals. The described techniques include receiving transaction requests that specify journal entries, and making those entries in the specified account journals. A cryptographic authentication tag is calculated for each journal entry, based on authentication keys of a forward-secure sequence of authentication keys. This allows a service to verify, in response to a client request, that the order of the entries has not been altered after creation of the entries. The transaction requests may be signed by the client and the signatures saved so that the service can also verify that the entries are as provided by the client.

### BACKGROUND

Bookkeeping is typically performed using what is referred to as double-entry accounting. With double-entry accounting, a financial transaction is recorded as a pair of offsetting entries to respective accounts, which together record a transfer of funds from one account to another. Accounts may correspond to assets, liabilities, equities, revenue, expenses, gains, and losses. A simple transaction may be recorded as a credit to one account and a debit, in an equal amount, to another account. More complex transactions may involve more than two entries and accounts.

Computerized accounting systems typically record debits and credits as entries in account journals, which may be implemented as database tables. It is important to protect the integrity of account journals such as this. When an accounting system is used by a business entity, malicious actors, both within the entity and outside of the entity, may try to alter journal entries in order to fraudulently obtain funds and/or credit, to falsify records for tax purposes, and/or to perpetuate other types of fraud.

### BRIEF DESCRIPTION OF THE DRAWINGS

The detailed description references the accompanying figures. In the figures, the left-most digit(s) of a reference number identifies the figure in which the reference number first appears. The use of the same reference numbers in different figures indicates similar or identical components or features.

FIG. 1 is a block diagram illustrating an example system for using and managing account journals.

FIG. 2 is a diagram illustrating an example structure of a transaction log that may be used within the system shown in FIG. 1.

FIG. 3 is a diagram illustrating an example structure of an account journal data structure that may be used within the system shown in FIG. 1.

FIGS. 4A, 4B, and 4C are block diagrams illustrating how authentication tags are created and associated with journal entries to allow detection of any reordering of the journal entries.

FIG. 5 is a flow diagram illustrating an example method of creating an account journal.

FIG. 6 is a flow diagram illustrating an example method of making journal entries in an account journal in response to transaction requests.

FIG. 7 is a flow diagram illustrating an example method for creating authentication tags and associating them with journal entries to allow detection of any reordering of the journal entries.

FIG. 8 is a flow diagram illustrating an example method for verifying the authentication tags of one or more journal entries.

FIG. 9 is a flow diagram illustrating an example method for verifying the authentication tag of a given journal entry.

FIG. 10 is a block diagram of an example server that may be used by a service provider or other entity to implement the techniques described herein.

### DETAILED DESCRIPTION

A journal manager is provided for use by multiple clients. The journal manager is accessible through a network-based application programming interface (API) and allows client components to create and maintain multiple account journals for use by an accounting system. The account journals are protected against alteration and reordering of entries using cryptographic techniques as will be described in more detail in the following discussion.

A client might comprise an accounting or bookkeeping application that implements double-entry accounting, as an example. The client may be configured to implement business logic, user interfaces, and various functionality. Rather than using local storage for account journals, however, the client is configured to use account journals that are maintained by the journal manager. Generally, a client might comprise any application that operates on any entries, while relying on the manager for protection against alteration and reordering of entries.

The journal manager can support multiple clients, which may include clients within the same organization that provides the journal manager, as well as clients that are external to the organization. In some cases, multiple services or applications of a single organization may use a common set of account journals to model various types of financial information, or even other types of non-financial information.

A client can access the API of the journal manager to create multiple account journals. The account journals may be used to record and track various types of financial information, such as the flow of money, or of obligations to pay money (e.g., of debts), through different parts or services of an organization. More generally, account journals may be used to model various types of financial transactions and exchanges, as well as other financial information such as liabilities, assets, revenue, expenses, gains, losses, etc. For example, a merchant services provider may create one account journal for its own bank account and another account journal for an account of a customer.

After an account journal has been created, the client may request that entries be made in the account journal. The entries of an account journal describe a sequence of debits and credits to a bookkeeping account corresponding to the account journal. When using double-entry accounting, a transaction is recorded as two or more offsetting journal entries, in respective account journals.

In a described embodiment, the client submits a transaction request that specifies data for two or more journal entries. Each transaction request may be digitally signed by the submitting client using a private key of an asymmetric cryptographic key pair. Upon receiving a transaction request, the journal verifies the signature using the corresponding public key to ensure that the transaction request was generated by the client. In addition, transaction signatures may be saved so that the authenticity of recorded transactions can be verified at any later time.

Journal entries are recorded in a sequence corresponding to an order in which corresponding transaction requests are received. To ensure that the order of the journal entries is not altered after creation, the journal manager creates an authentication tag for each sequential entry of an account journal using a corresponding key of a forward-secure key sequence. More specifically, the journal manager uses an ordered, forward-secure sequence of authentication keys for each account journal, and uses the authentication keys in sequence to create cryptographic authentication tags for sequentially corresponding entries of the account journal. For example, the authentication tag of the initial journal entry is created based on the initial authentication key of the sequence, the authentication tag of the next journal entry is created based on the next authentication key, and so forth. The authentication tag of each journal entry is saved with or associated with that journal entry. However, the keys that are used to create the authentication tags are not saved.

In some embodiments, the sequence of authentication keys for an account journal is created so that each authentication key can be derived from the previous authentication key, with the initial authentication key being derived from a root key that is unique to each account journal. The authentication keys are calculated in a way that provides forward security, so that while a given authentication key can be derived from a previous key of the sequence, knowledge of the given authentication key does not allow derivation of any previous key of the sequence.

In order to verify that a sequence of journal entries has not been reordered, the sequence of authentication keys can be reconstructed based on the root key, which is stored securely by a trusted entity. Once the key sequence is reconstructed, the keys of the sequence can be used to regenerate the authentication tags of the account journal, and the regenerated authentication tags can be compared to the authentication tags that were saved with the journal entries. A discrepancy indicates either that the order of the entries has been altered or that the content of an entry has been altered.

In some embodiments, a key sequence can be created as a seekable key sequence, so that any given key of the sequence can be calculated based on its position within the sequence, without calculating the keys that precede the given key. In cases where a seekable key sequence is used, the authentication tag of an individual journal entry can be created and/or verified based on the root key, without calculating the entire sequence of keys.

The techniques described herein address situations in which a malicious actor might try to alter journal entries, create new journal entries, delete existing journal entries, and/or change the order of entries in a journal. The described techniques associate a signature with each transaction request so that any alterations of transaction data can be detected. The techniques also protect against journal alterations by associating an authentication tag with each entry, where the authentication tags of the entries of a journal are created using a forward-secure sequence of authentication keys that would be difficult to reproduce based on available information. The described techniques furthermore provide efficient techniques for generating and verifying the authentication tags.

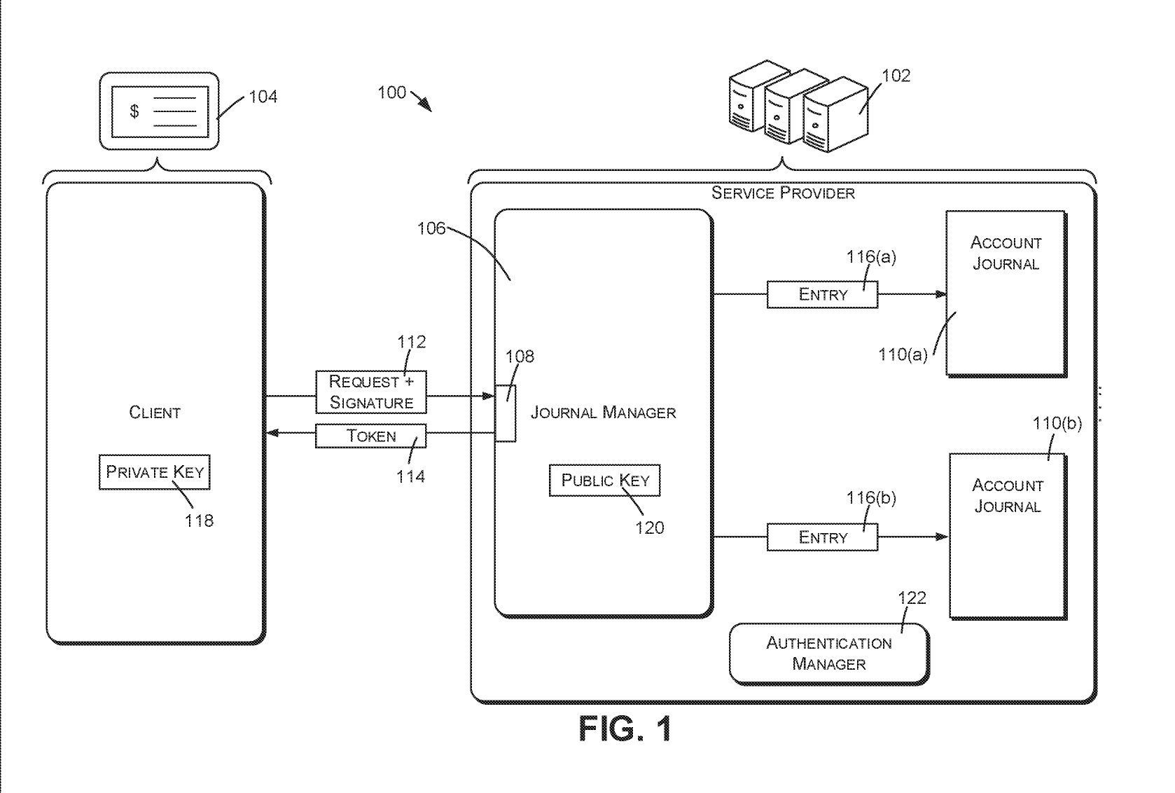

FIG. 1 shows a system 100 that uses a journal manager for managing account journals for multiple clients. For example, account journals may be created for use by various types of businesses to track balances of multiple financial accounts.

The system 100 comprises a service provider 102 configured to provide services to multiple clients, of which a single client 104 is shown in FIG. 1. The service provider 102 may provide services using one or more computer servers and other resources that are accessible through a wide-area network, which may include the Internet. In the illustrated embodiment, the service provider 102 provides a journal management service 106, also referred to herein as a journal manager 106. The journal manager 106 has a network-accessible API 108 that can be accessed by clients for managing account journals.

Although FIG. 1 shows the journal manager 106 being accessed by a client that is external to the service provider 102, in some cases the service provider 102 may implement the journal manager 106 for its own internal use, to be accessed by various services and/or applications of the service provider itself.

The client 104 may comprise a computer and/or software configured to manage or track financial information for a person, business, or other entity. For example, the client 104 may comprise an accounting application used by a person or business. The accounting application may be configured to provide a graphical user interface (GUI) for a user and to implement business logic for receiving, storing, and reporting financial information, with the support of the journal manager 106 and the API 108.

In other embodiments, the client 104 may comprise an automated system or service that provides services other than accounting. For example, the client 104 may comprise a merchant services provider that provides services to merchants. As a specific example, such a client may provide support for processing card-based transactions on behalf of the merchants. A merchant may use the merchant services provider for payment processing, and the merchant services provider may use the journal manager 106 to track funds.

Generally, the client 104 may comprise any hardware and/or software of a person, business, or other entity.

The journal manager 106 may maintain any number of account journals for a given client, and may maintain account journals for multiple clients. For instance, the journal manager 106 may maintain multiple account journals 110 for the client 104, of which two account journals 110(a) and 110(b) are shown in FIG. 1. The client 104 may communicate with the journal manager 106 through the API 108 to request the creation of the account journals 110.

Each account journal 110 comprises a table or other data structure having multiple journal entries. Each journal entry comprises a data entry indicating the amount of a credit or debit associated with a corresponding transaction. Each journal entry may also specify other information as will be described below.

The client 104 can submit a request 112 to the journal manager 106 through the API 108. Requests may be submitted to create account journals, to make entries to the account journals, and to read information from previously created account journals.

A request to create an account journal 110 may specify information such as a name for the requested account journal. In response, the journal manager 106 creates the account journal 110 and returns a token 114 to the client 104 by which to reference the account journal 110.

The journal manager 106 makes entries 116 to the account journals 110 in response to transaction requests from the client 104. A transaction request specifies a transaction in terms of a debit amount to one account and a credit amount to another account. Specifically, the transaction request specifies the journal accounts associated with the transaction and the respective entries or amounts to be credited or debited to each journal account. A single transaction request may at times specify more than two journal accounts 110 to be credited or debited. A series of multiple transactions, received over time, may indicate an ordered sequence of journal entries.

In the example of FIG. 1, a transaction request results in two offsetting entries, shown as an entry 116(a) and an entry 116(b), to the account journals 110(a) and 110(b).

The journal manager 106 may enforce rules to ensure that the account journals 110 are used correctly, in accordance with double-entry accounting practices. Specifically, the journal manager 106 may return an error in response to a transaction request specifying credits and debits that do not sum to zero.

Communications between the client 104 and the journal manager 106 may be encrypted for security. In addition, requests, or the data specified by the requests, may be digitally signed by the client 104 to ensure that the requests have indeed been provided or authorized by the client 104. Specifically, transaction data may be signed by the client 104 using the private key 118 of a cryptographic asymmetric key pair, which is secret to the client 104. The journal manager 106 then verifies the signatures of the transaction requests using the public key 120 of the asymmetric key pair. In certain embodiments, the journal manager 106 may save the transaction signatures along with transaction data. This makes it possible to verify the authenticity of transaction data at any time.

In addition to the components already described, the service provider 102 may have an authentication manager 122. The authentication manager 122 can be configured to implement various functionality relating to authentication keys, as will be described in more detail below. As an example, the authentication manager 122 may be called to verify that journals have not been tampered with. The client 104 or the journal manager 106 can submit a token to the authentication manager 122, requesting that the authentication manager 122 verify the integrity of the account journal 110 corresponding to the token. Further aspects and functionality of the authentication manager 122 will be described below.

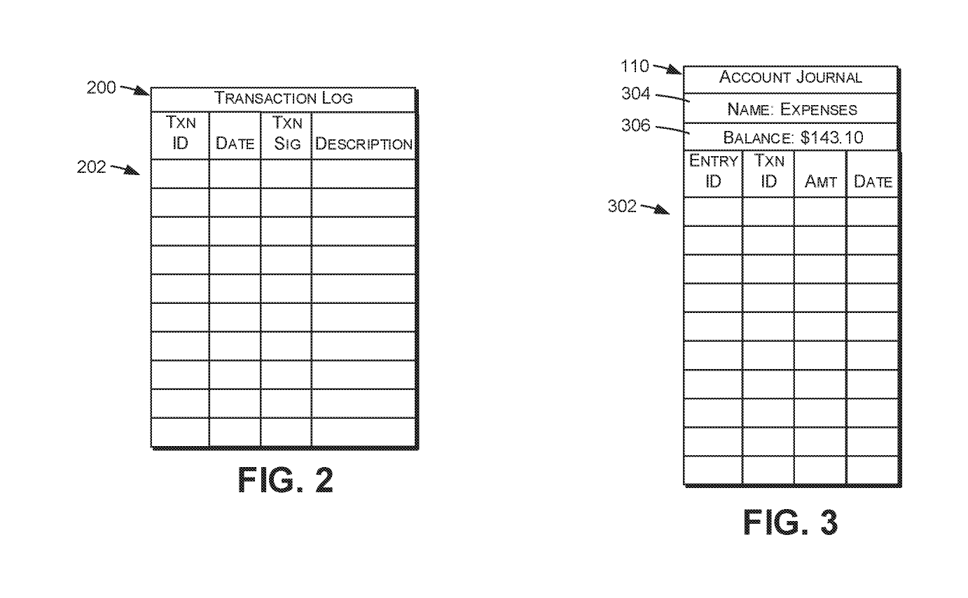

FIG. 2 shows an example transaction log 200 that may be created and used by the journal manager 106, in conjunction with multiple account journals 110, for recording transaction information. The transaction log 200 has rows 202 corresponding respectively to transactions that have been recorded by the journal manager 106. In this example, each row 202 corresponds to an individual transaction and specifies a transaction ID (Txn ID), a date, a transaction signature (Txn Sig), and a description.

The transaction identifier is an index that is unique to each row of the transaction log 200, and indicates the order in which the transactions were recorded. The date represents the effective date of the recorded transaction. The transaction signature is the signature provided by the client 104, which was created using the private key 118 of the client 104. The description is a textual field with information regarding a transaction, as specified by the client 104. Depending on implementation, a transaction log may include various additional types of information.

FIG. 3 shows an example of an account journal 110. The account journal 110 is a data structure having multiple journal entries 302, shown as rows of a table. The account journal 110 also has a name field 304 for recording the name of the account journal 110 and a balance field 306 for recording the current balance of the account represented by the account journal 110.

In this example, each journal entry 302 specifies an entry identifier (Entry ID), a transaction identifier (Txn ID), an amount (AMT), and a date. The entry identifier is an index that is unique to each entry of the journal 110, and indicates the order in which the journal entries were made. The transaction identifier is a reference to the transaction identifier of the transaction log 200, and indicates the transaction of which the journal entry was a part. The amount specifies either a debit amount or a credit amount. The date represents the effective date of the transaction of which the journal entry was a part. Note that in some implementations, the journal entry 302 might have a field for a debit amount and a separate field for a credit amount. Each journal entry may include various other types of information.

The transaction log 200 and the account journals 110 may be implemented as tables of a relational database in some embodiments.

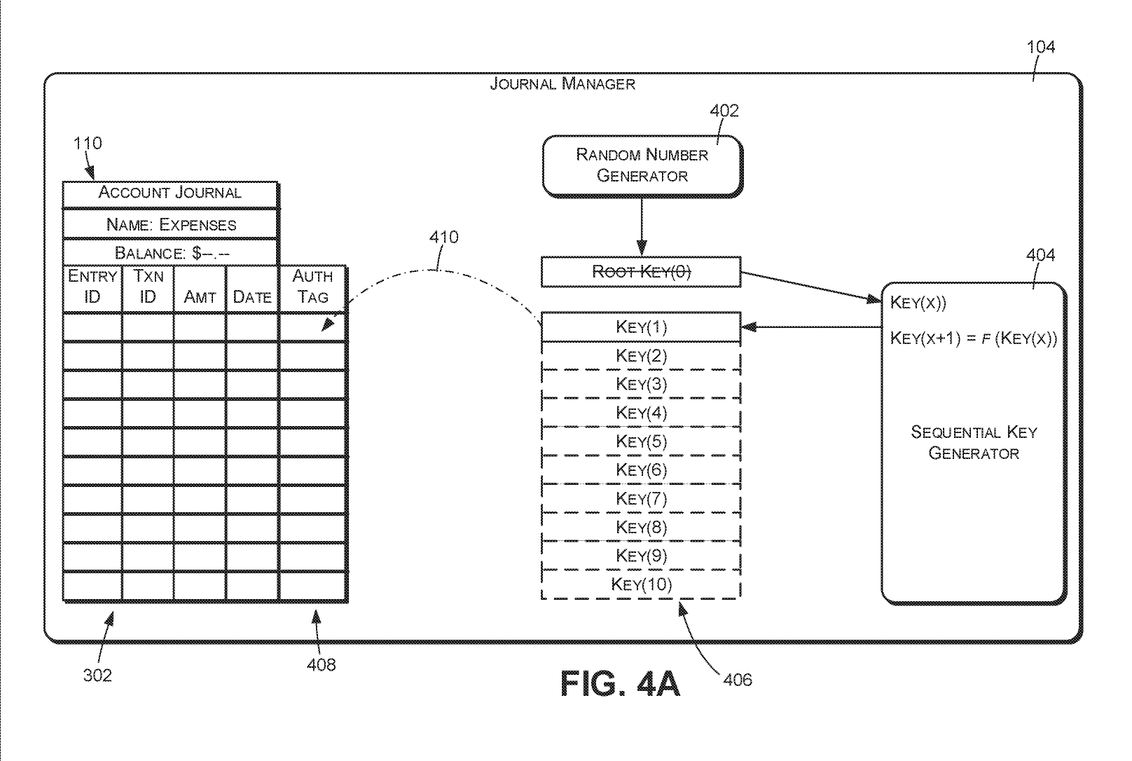

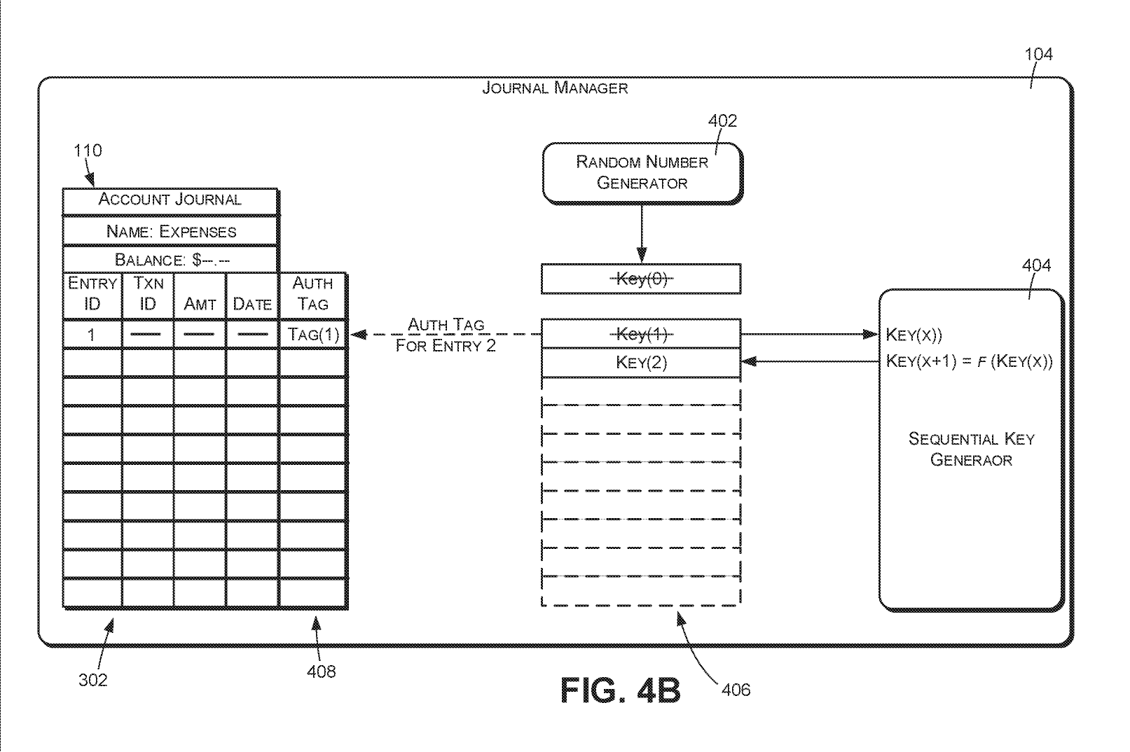

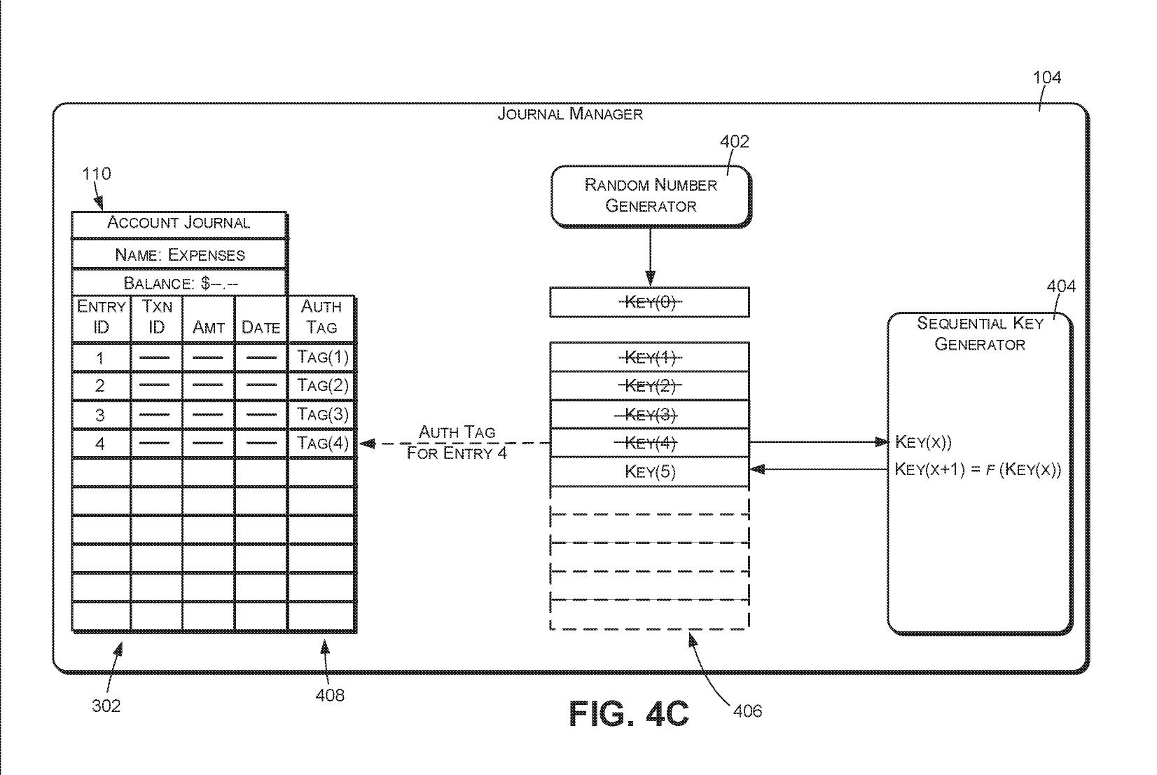

FIGS. 4A through 4C illustrate how authentication tags are created and associated with journal entries in order to prevent and/or allow detection of tampering with the order of the entries of an account journal.

The journal manager 106 has a random number generator 402 and a sequential key generator 404, which are used to create an ordered sequence of authentication keys 406, referred to herein as Key(0) through Key(N+1), where N is the number of journal entries in the account journal 110. The sequence is created so that it has forward security. Thus, knowledge of a given key does not allow any previous keys to be inferred.

FIGS. 4A through 4C show positions of the initial 10 authentication keys of the authentication keys 406, relative to the positions of the multiple entries 302 of the account journal 110. Dashed blocks indicate positions in the sequence for which the corresponding keys have not yet been calculated. The authentication keys 406 are used to create authentication tags 408 corresponding respectively to the journal entries 302 (as shown by arrow 410 in FIG. 4A).

Upon creation of the account journal 110, the journal manager 106 uses the random number generator 402 to create a pseudo-random number or string that is used as a root key for generating the sequence of authentication keys 406. Each authentication key 406 is shown as Key(i), where i is the position of the key within the sequence of keys. Key(0) is referred to as the root key. Key(l) is referred to as the initial authentication key. In addition to Key(0), Key(l) is also created upon creation of the account journal 110.

The sequential key generator 404 calculates Key(l) through Key(N+1) based on the root key. Specifically, the sequential key generator 404 produces a new key by applying a function ƒ to an existing key. More specifically, any key Key(x+1) is calculated by applying the function ƒ to the previous key Key(x): Key(x+1)=ƒ(Key(x)). Key(1) is created by applying the function ƒ to the root key: Key(1)=ƒ(Key(0)).

The function ƒ may comprise or use a one-way function, such as a cryptographic hash function, in order to be cryptographically secure. The use of a one-way function results in a sequence of authentication keys that is forward secure, meaning that knowledge of a given key does not allow any previous keys to be inferred. Note that although the authentication keys are described herein as being symmetric keys, asymmetric keys may also be used in some embodiments to generate authentication tags.

After generating Key(l), the root key is sent to the authentication manager 122 for safekeeping. The authentication manager 122 is implemented as an application or service that is isolated from the journal manager 106, so that the journal manager 106 does not have access to the root key. In some implementations, the random number generator 402 may be part of the authentication manager 122, and rather than providing the root key to the journal manager 106, the authentication manager 122 may generate the root key and Key(l), securely store the root key, and provide only Key(l) to the journal manager 106. This ensures that the journal manager itself does not have access to the root key.

In some cases, the root key may be provided to the client 104 for safekeeping, and deleted from the journal manager 106 after Key(l) has been generated.

FIG. 4B illustrates creation of the initial journal entry in the account journal 110, identified as the entry whose entry ID equals 1. An authentication tag Tag(1) is calculated based on Key(1). In addition, the sequential key generator 404 calculates and saves the next key, Key(2), by applying the function ƒ to Key(1). Key(1) is deleted, as indicated by strikethrough text. Subsequent keys have not yet been calculated.

There are various ways that an authentication tag can be created for a journal entry. For example, the authentication tag may comprise a message authentication code, often referred to as a MAC, which is calculated based on the fields of the journal entry and the corresponding authentication key. Alternatively, a digital signature scheme might be used in conjunction with an asymmetric key pair to generate a signature of the journal entry. In this case, the signature would be used as the authentication tag.

Generally, an authentication tag of a journal entry may be a code or other token that is created based at least in part on the journal entry, and which after creation would be computationally infeasible to obtain without knowledge of the authentication key.

FIG. 4C illustrates the creation of a fourth journal entry of the account journal 110, after the initial three entries have been created and signed. A corresponding authentication tag Tag(4) is calculated based on Key(4). The sequential key generator 404 calculates and saves the next key, Key(5), by applying the functionfto Key(4). Finally, Key(4) is deleted.

Any number of journal entries may be created and signed in this manner. After each authentication tag is created, the authentication key used to create the authentication tag is deleted, so that only a single authentication key is available at any time. Because the sequential key generator 404 produces a key sequence having forward security, previous authentication keys cannot be derived from the currently stored and available authentication key.

Verification of the entries of an account journal can be performed by the authentication manager 122, in response to a request by the client 104 or the journal manager 106. For example, the client 104 may provide a token corresponding to the account journal 110, and request that the authentication manager 122 verify that the entries of the account journal 110 are in their original order. In some embodiments, particularly where the key sequence is seekable, the client 104 may request verification of any individual entries of the account journal 110. Example methods of verifying entry order within an account journal will be described below.

Responsibility for the functionality described above may be distributed in ways other than shown in FIGS. 4A, 4B, and 4C. For example, in some embodiments the random number generator 402 and the sequential key generator 404 may be implemented by the authentication manager 122. In these embodiments, it may be that the journal manager 106 calls the authentication manager 122 to obtain each sequential key. Furthermore, in some embodiments the authentication manager 122 may be responsible for calculating authentication tags of specified journal entries, based on specified entry data and corresponding authentication keys that are kept secret from the journal manager 106.

The techniques described herein provide protection against (a) fraudulent creation or alteration of journal entries and (b) reordering of journal entries. Verifying that a journal entry was generated by the client and that the entry has not since been altered can be accomplished by verifying the transaction signature of the transaction that specified the journal entry. The original order of the journal entries 302 may be verified at any time by obtaining the root key associated with the account journal, recalculating the original sequence of keys 406 based on the root key, recalculating the authentication tags of the entries using the recalculated keys, and verifying that the recalculated authentication tags match the respectively corresponding stored authentication tags 408.

The techniques described herein may be used by any entity to model exchanges of cash, value, liabilities, assets, and so forth. Furthermore, account journals can be created for use in common by multiple entities, services, or computing components. As an example, a company such as a merchant services provider may provide multiple services, each of which might be implemented independently of the others. Even though the services are independent, they may use a common set of account journals to model or track the flow of money within the company. Different organizations may also in some cases use one or more common account journals.

The API 108 may be implemented as an HTML RESTful interface, particularly when the journal manager 106 is used by clients external to the service provider 102. When using an HTML RESTful interface, data such as transaction data can be represented in a structured manner, using XML for example. In other cases or implementations, data may be packaged or structured using protocol buffers. Regardless of the technique used for representing transaction data, the client 104 and the journal manager 106 should have an agreed upon manner of serializing or otherwise representing transaction data so that transaction signatures generated by the client 104 can be compared to corresponding signatures generated by the journal manager 106.

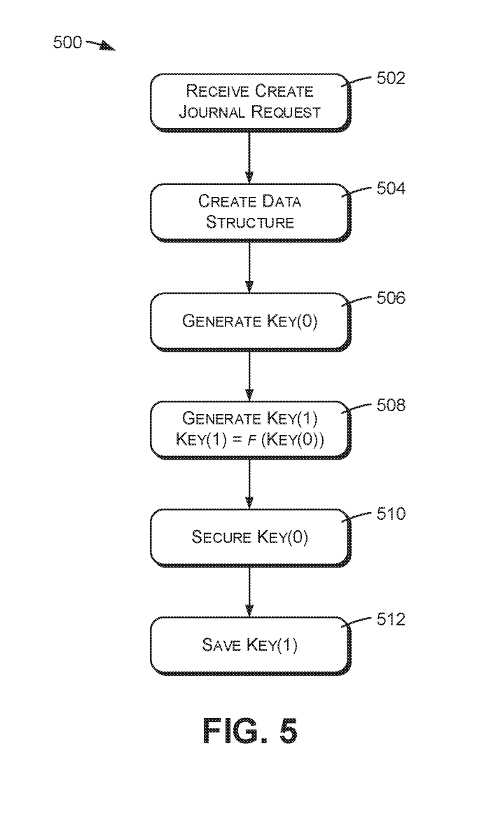

FIG. 5 illustrates an example method 500 of creating an account journal for use with or by an accounting system. The example method 500 may be performed in the environment of FIG. 1, and the actions of the method 500 may be performed by the journal manager 106 and/or by the authentication manager 122. The method 500 may also be performed in other environments, by other types of computing components.

An action 502 comprises receiving a request to create an account journal. The request may be received from a client device or software component. The request may specify a name for the account journal, and may also specify other relevant information.

An action 504 comprises creating a data structure for the requested account journal, such as by creating a table in a database.

An action 506 comprises generating a root key Key(0). In certain embodiments, the action 506 may comprise generating a random number or string to be used as the root key, where the term “random” is intended to include “pseudo-random”.

An action 508 comprises calculating Key(l) for the requested account journal. As already described, the initial key, Key(l), may be calculated by applying a one-way, forward-secure function ƒ to Key(0).

An action 510 comprises securing the root key. For example, the root key may be sent to a separate service or software component. As another example, the root key may be returned to the client for safeguarding. The action 510 includes deleting the root key from the memory of the journal manager 106, and/or from memory that is accessible to the journal manager 106.

An action 512 comprises saving Key(l) in memory accessible to the journal manager 106, so that it can be used for signing a subsequently created journal entry.

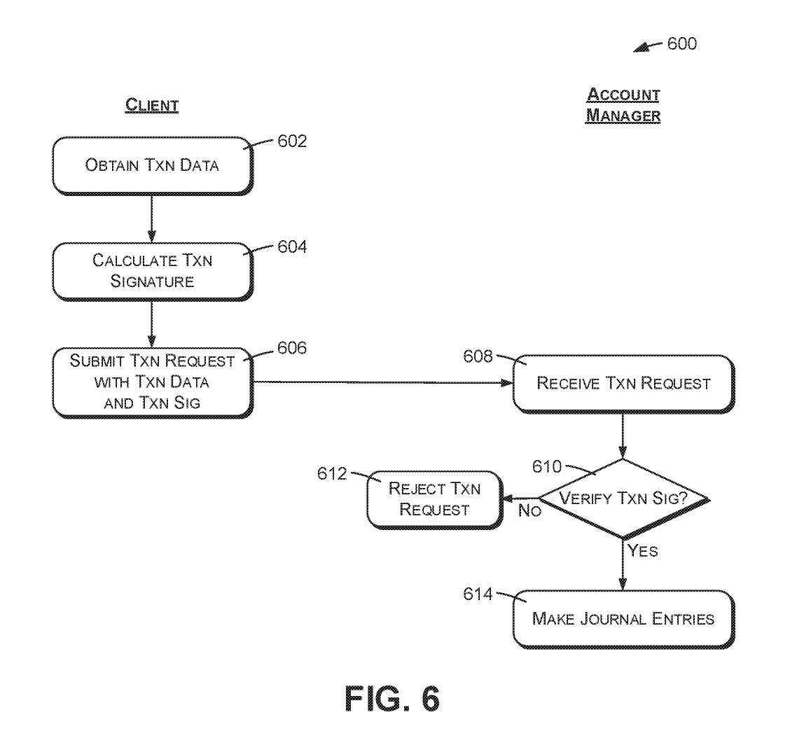

FIG. 6 illustrates an example method 600 that may be performed in the environment of FIG. 1 to manage account journals having entries corresponding to a temporally ordered sequence of accounting transactions. The method 600 is implemented so as to prevent tampering with entries of the account journals. Specifically, the method 600 is implemented so as to prevent or allow detection of (a) alterations to individual entries and to (b) reordering of the entries of any individual account journal.

Actions on the left of FIG. 6 may be performed by the client 104 of FIG. 1. Actions on the right of FIG. 6 may be performed by the journal manager 106 and/or authentication manager 122 of FIG. 1. The method 600 may also be implemented in other environments, and the actions performed by entities other than those shown in FIG. 1.

An action 602 comprises obtaining data specifying a transaction, which is referred to herein as transaction data. Generally, transaction data specifies data for two or more journal entries. Each journal entry is specified by identifying an account journal and indicating either a credit amount or a debit amount to be entered in that account journal. A client may determine the parameters of a transaction using appropriate business logic.

An action 604 comprises calculating a signature of the transaction or the transaction data. The transaction signature may be created using a private key 118 of an asymmetric cryptographic key pair, for example. The cryptographic key pair is generated or obtained by the client and the public key 120 of the pair is shared with the journal manager 106. The private key 118 is held by the client 104 and is not divulged to the journal manager 106.

In some embodiments, the client 104 may concatenate the individual items of the transaction data, and then sign the resulting string with the private key 118. A signature may be created, for example, by calculating a hash of the concatenated transaction data, encrypting the hash using the private key 118 of the client 104, and using the encrypted hash as the signature. The signature may be verified by the journal manager 106 and/or authentication manager 122 by recalculating the hash of the transaction data, decrypting the transaction signature using the public key 120 for the client to reveal the hash previously calculated by the client 104, and verifying that the recalculated hash is the same as the hash previously calculated by the client 104.

In certain embodiments, the transaction signature may be generated using what is referred to as elliptic curve encryption, which uses a relatively small amount of memory for storage of keys and signatures. Other types of encryption may alternatively be used to create the transaction signature.

An action 606 comprises submitting a transaction request, to the journal manager 106, to record a transaction of the temporally ordered sequence of financial transactions. The transaction request specifies the transaction data, which in turn specifies multiple entries to be made in respective account journals. For each journal entry, the transaction request may specify the name of an account journal and an amount that is to be either credited or debited in the account journal.

An action 608, performed by the journal manager 106, comprises receiving the transaction request.

An action 610, also performed by the journal manager 106, comprises verifying the transaction signature specified by the transaction request. Verification is performed as described above, using the public key 120 of the client, which corresponds to the private key 118 used to create the transaction signature. The action 610 is performed to verify that the transaction request was received, unaltered, from an authorized client.

If the transaction signature is not verified, an action 612 is performed, which comprises rejecting the transaction request. For example, a message might be returned to the client 104 that the request was refused. This might happen, for example, if transaction data specified by the transaction request has been altered, or if the transaction request has been forged by an imposter.

If the transaction signature is verified, an action 614 is performed of creating new journal entries to record the transaction data of the transaction request. Verification of the transaction signature indicates that the transaction request was created by the client 104 and that the transaction request was not tampered with since it was created by the client 104.

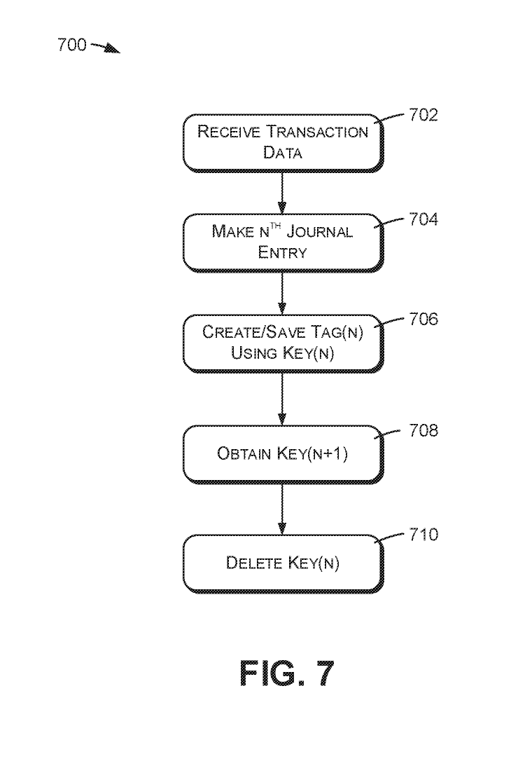

FIG. 7 illustrates an example method 700 that may be performed in the environment of FIG. 1 to make journal entries in an account journal and to prevent reordering of the journal entries. The method 700 may be used to implement the action 614 of FIG. 6, for example, to record at least a portion of the transaction data specified by the transaction request. Specifically, the method 700 might be invoked or initiated multiple times to create the journal entries of the action 614.

In the environment of FIG. 1, the method 700 may be performed by the journal manager 106 and/or the authentication manager 122. The method 700 may be performed by other components or entities in other environments.

The method 700 assumes the use of a forward-secure sequence of authentication keys. An individual key is referred to as Key(n), where n indicates that the key is the n^{th} key in the sequence.

An action 702 comprises receiving transaction data for a transaction of an ordered sequence of transactions. The transaction data might be specified by a transaction request, for example. The transaction data may specify journal entry data. The journal entry data may specify a name of an account journal, an amount to be credited or debited in the journal, and other related data.

An action 704 comprises making a journal entry to record at least a portion of the transaction data. Specifically, this action may comprise creating a new journal record in a database and saving journal entry data or information such as a date and an amount of a credit or debit. Journal entries may be structured as shown in FIG. 3, as one example. For purposes of discussion, it will be assumed that the new journal entry is the n^{th} entry in the account journal.

An action 706 comprises creating an authentication tag for the journal entry using the n^{th} authentication key Key(n) of the forward-secure sequence of authentication keys. More specifically, the action 706 may comprise calculating an authentication tag corresponding to the n^{th} journal entry that was made in the action 704. In described embodiments, an authentication tag corresponding to the n^{th} journal entry is generated based at least in part on the corresponding sequential key Key(n), which is the n^{th} key of the sequence of forward-secure authentication keys. The action 706 may also include storing the authentication key in association with the journal entry. In some embodiments, the authentication key may be saved in the same table that stores the journal entry.

An action 708 comprises obtaining Key(n+1), where Key(n+1) immediately follows Key(n) in the ordered sequence of sequence keys. In some embodiments, the action 708 may comprise calculating Key(n+1) based on Key(n), such as by applying a one-way function to Key(n). The newly calculated Key(n+1) is saved for future use during the next iteration of the method 700, when creating the next journal entry.

In some embodiments, the ordered sequence of sequence keys may be seekable, and it may be possible to obtain Key(n+1) based on the root key of the forward-secure sequence of authentication keys, without relying on Key(n). In embodiments such as this, the journal manager 106 may query the authentication manager 122 to obtain the next key, when needed. The authentication manager 122 responds to the query by calculating Key(n+1) based on the root key corresponding to the account journal. In these embodiments, the action 708 may be performed on demand, such as whenever the journal manager 106 needs a key to obtain the authentication tag of a new journal entry.

Examples of techniques for creating seekable sequential keys, are described in Marson et al., “Practical Secure Logging: Seekable Sequential Key Generators”, Computer Security—ESORICS 2013: 18th European Symposium on Research in Computer Security, 2013, and Marson et al., “Even more practical secure logging: Tree-based Seekable Sequential Key Generators”, Computer Security—ESORICS 2014: 19th European Symposium on Research in Computer Security, Part 2, 2014, for example.

An action 710 comprises deleting Key(n) from any memory that is directly accessible by the journal manager 106. Discarding Key(n) after it has been used ensures that the journal manager itself will be unable, in the absence of the root key, to alter the newly created journal entry or to change its position. Because the root key is stored by a component other than the journal manager, the journal manager does not have access to the root key and cannot alter or change the position of the journal entry.

The method 700 may be performed repeatedly to record and create authentication tags for an ordered sequence of journal entries, based on transaction data received by way of multiple transaction requests. For example, the method 700 may be performed to record a first journal entry of the ordered sequence of journal entries in response to a first transaction request, using a corresponding authentication key of the forward-secure sequence of authentication keys. The method 700 may then be performed again to record a second journal entry of the ordered sequence of journal entries in response to a second transaction request, again using a corresponding authentication key of the forward-secure sequence of authentication keys.

Note that as used herein, the terms “first”, “second”, and “third” are used to distinguish between different instances of elements rather than to indicate any particular position or order.

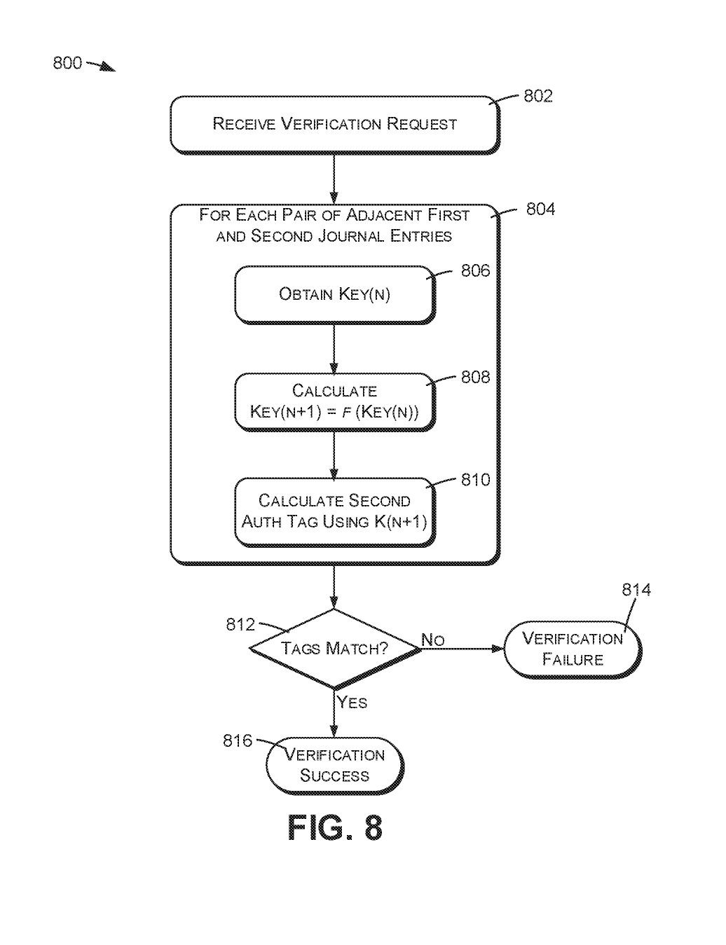

FIG. 8 illustrates an example method 800 of verifying that the order of entries in an account journal has not been tampered with or otherwise changed. In the described embodiment, the method 800 may be performed by the authentication manager 122, although the method 800 may also be performed by other components and in other environments.

An action 802 comprises receiving a request, referred to herein as a verification request, to verify the authenticity of one or more journal entries of a specified account journal, and to verify that the order of the one or more journal entries has not been altered.

A set of actions 804 is performed for each pair of first and second journal entries that are immediately adjacent each other in the account journal, where the first journal entry precedes the second journal entry but is not necessarily the initial entry of the account journal.

An action 806 comprises obtaining a first authentication key Key(n) of a forward-secure authentication key sequence. Key(n) is based on a root key associated with the account journal, and n is the position of the first journal entry within the sequence of journal entries of the account journal.

An action 808 comprises calculating a second authentication key Key(n+1) based at least in part on the first authentication key Key(n). The second authentication key Key(n+1) may in some embodiments be calculated by applying the one-way function ƒ to the first authentication key Key(n).

An action 810 comprises calculating an authentication tag of the second journal entry using the second authentication key Key(n+1).

The actions 804 result in authentication tags being recalculated for each of the entries in the account journal. An action 812 comprises verifying that the recalculated authentication tags match the authentication tags that were associated and/or saved with the journal entries. If the authentication tags do not match, the verification fails as indicated at 814, indicating that either (a) a journal entry has been altered or (b) one or more journal entries have been reordered. If the authentication tags match, the verification succeeds as indicated at 816.

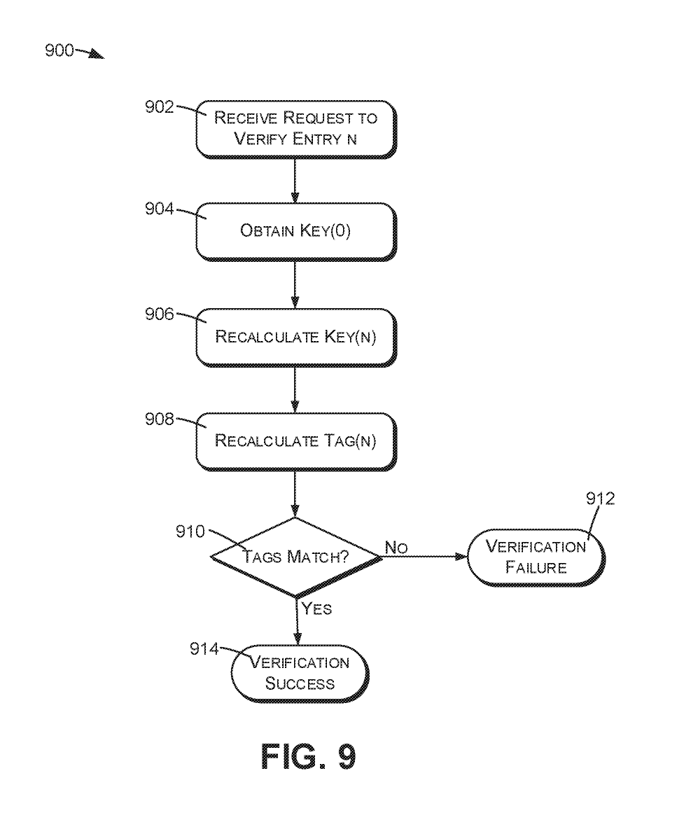

FIG. 9 illustrates another example method 900 of verifying that the order of entries in an account journal has not been tampered with or otherwise changed. In the described embodiment, the method 900 may be performed by the authentication manager 122, although the method 900 may also be performed by other components and in other environments.

An action 902 comprises receiving a request, referred to herein as a verification request, to verify the authenticity of one or more journal entries. In this example, the verification request specifies an entry index n, corresponding to the index ID of a journal entry that is to be verified. The verification request may also specify a name of the account journal whose entry is to be verified.

An action 904 comprises obtaining the root key of the account journal specified by the verification request. The root key may in some cases be specified by the verification request.

An action 906 comprises recalculating or otherwise deriving the n^{th} key of the key sequence used for the specified account journal, where the n^{th} key Key(n) corresponds to the n^{th} journal entry. The n^{th} key is recalculated based at least in part on the root key used to generate the key sequence.

Depending on the method used to originally generate the key sequence, the action 906 may be performed in different ways. For embodiments in which the key sequence is seekable, the n^{th} key can be determined from the root key without determining previous keys in the key sequence. Otherwise, for embodiments in which the key sequence is not seekable, the action 906 may comprise determining keys 1 through n, or every key that precedes the n^{th} key in the key sequence. In this case, each Key(n) is calculated by applying the previously discussed one-way, forward-secure functionfto Key(n−1) as follows: Key(n)=ƒ (Key(n−1)).

An action 908 comprises recalculating the authentication tag of the n^{th} journal entry, based at least in part on the recalculated Key(n).

An action 910 comprises verifying that the recalculated authentication tag of the n^{th} journal entry matches the authentication tag that was associated and/or saved with the n^{th} journal entry. If the authentication tags do not match, the verification fails as indicated at 912, indicating that either (a) the n^{th} journal entry has been altered or (b) the n^{th} journal entry has been moved to a different position. If the authentication tags match, the verification succeeds as indicated at 914.

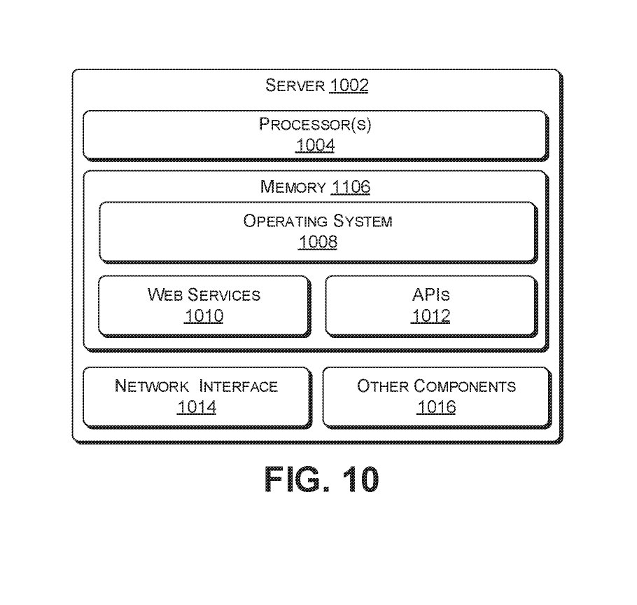

FIG. 10 shows an example of a computing device 1002, which may be used to implement the functionality of the journal manager 106. Generally, the journal manager 106 and other components of the service provider 102 may be implemented by a plurality of computing devices 1002, configured as servers. The computing devices may be programmed or otherwise configured to perform the actions that are attributed herein to components of the service provider 102. One or more computing devices 1002 such as shown in FIG. 10 may similarly be used to implement the client 104.

Generally, the computing device 1002 may comprise a general purpose or specialized computer, such as a desktop computer or rack-mounted computer. In the illustrated example, the computing device 1002 includes at least one processor 1004 and associated memory 1006. Each processor 1004 may itself comprise one or more processors or processing cores. For example, the processor 1004 can be implemented as one or more microprocessors, microcomputers, microcontrollers, digital signal processors, central processing units, state machines, logic circuitries, and/or any devices that manipulate signals based on operational instructions. In some cases, the processor 1004 may be one or more hardware processors and/or logic circuits of any suitable type specifically programmed or configured to execute the algorithms and processes described herein. The processor 1004 can be configured to fetch and execute computer-readable processor-executable instructions stored in the memory 1006.

Depending on the configuration of the computing device 1002, the memory 1006 may comprise tangible non-transitory computer-readable storage media and may include volatile and nonvolatile memory and/or removable and non-removable media implemented in any type of technology for storage of information such as computer-readable processor-executable instructions, data structures, program modules or other data. The memory 1006 may include, but is not limited to, RAM, ROM, EEPROM, flash memory, solid-state storage, magnetic disk storage, optical storage, and/or other computer-readable media technology. Further, in some cases, the computing device 1002 may access external storage, such as RAID storage systems, storage arrays, network attached storage, storage area networks, cloud storage, or any other medium that can be used to store information and that can be accessed by the processor 1004 directly or through another computing device or network. Accordingly, the memory 1006 may be computer storage media able to store instructions, modules or components that may be executed by the processor 1004. Further, when mentioned, non-transitory computer-readable media exclude media such as energy, carrier signals, electromagnetic waves, and signals per se.

The memory 1006 may be used to store and maintain any number of functional components that are executable by the processor 1004. Generally, functional components comprise instructions or programs that are executable by the processor 1004 and that, when executed, implement operational logic for performing the actions and services attributed above to the service provider 102 and/or the client 104.

Additional functional components may include an operating system 1008 and a web services component 1010. The memory 1006 may also store APIs (application programming interfaces) 1012 that are used for communications between the computing device 1002 and other network-accessible entities. The memory 1006 may also store data, data structures and the like, that are used by the functional components.

The computing device 1002 may have a network communications interface 1014, such as an Ethernet communications interface, which provides communication by the computing device 1002 with other servers, with the Internet, with POS devices and/or other peripherals or terminals, etc.

The computing device 1002 may of course include many other logical, programmatic, and physical components 1018 that are not specifically described herein.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

1. A method for preventing tampering with two or more account journals associated with a merchant, the method performed by one or more computer servers associated with a network-based accounting service, the method comprising:
providing, by the one or more computer servers associated with the network-based accounting service and to a client device operable by the merchant, an interface enabling the merchant to record transactions in the two or more account journals of the merchant, wherein the two or more account journals are managed by the network-based accounting service;
receiving, via a first input to the interface and by the one or more computer servers associated with the network-based accounting service, a first request to record a first transaction of a temporally ordered sequence of transactions associated with the merchant, wherein the first request specifies first transaction data to be recorded in two or more journal entries and a transaction signature created with a private key of an asymmetric cryptographic key pair of the merchant;
verifying, via the one or more computer servers associated with the network-based accounting service, the transaction signature using a public key of the asymmetric cryptographic key pair to confirm that the first request is from the merchant;
adding, via the one or more computer servers associated with the network-based accounting service, a first journal entry in a first account journal of the two or more account journals to record at least a portion of the first transaction data;
adding, via the one or more computer servers associated with the network-based accounting service, a second journal entry in a second account journal of the two or more account journals to record at least another portion of the first transaction data, wherein the second journal entry at least partially offsets the first journal entry;
determining, via the one or more computer servers associated with the network-based accounting service, a first authentication tag of the first journal entry based at least in part on a first sequential key, wherein the first authentication tag comprises a message authentication code determined based on a plurality of fields of the first journal entry and the first sequential key;
associating, via the one or more computer servers associated with the network-based accounting service, the first authentication tag with the first journal entry;
calculating, via the one or more computer servers associated with the network-based accounting service, a second sequential key by applying a one-way function to the first sequential key;
discarding, via the one or more computer servers associated with the network-based accounting service, the first sequential key;
receiving, via a second input to the interface and by the one or more computer servers associated with the network-based accounting service, a second request to record a second transaction, wherein:
the second request specifies second transaction data to be recorded in two or more additional journal entries;
the two or more additional journal entries offset one another in different account journals of the two or more account journals; and
the second transaction is immediately subsequent to the first transaction in the temporally ordered sequence of transactions;
adding, via the one or more computer servers associated with the network-based accounting service, a third journal entry in the first account journal to record at least a portion of the second transaction data;
determining, via the one or more computer servers associated with the network-based accounting service, a second authentication tag of the third journal entry based at least in part on the second sequential key;
associating, via the one or more computer servers associated with the network-based accounting service, the second authentication tag with the third journal entry;
discarding, via the one or more computer servers associated with the network-based accounting service, the second sequential key; and
verifying, via the one or more computer servers associated with the network-based accounting service, an integrity of the first account journal based on at least one of the first authentication tag or the second authentication tag.

2. The method of claim 1, wherein verifying the integrity of the first account journal comprises:
receiving a third request to verify an authenticity of the second authentication tag;
recalculating the second sequential key based at least in part on a root key;
determining a third authentication tag of the third journal entry based at least in part on recalculating the second sequential key; and
verifying that the third authentication tag matches the second authentication tag.

3. The method of claim 1, wherein verifying the integrity of the first account journal comprises:
receiving a third request to verify an authenticity of the third journal entry;
obtaining the first sequential key;
recalculating the second sequential key by applying the one-way function to the first sequential key;
determining a third authentication tag of the third journal entry based at least in part on recalculating the second sequential key; and
verifying that the third authentication tag matches the second authentication tag.

4. The method of claim 1, wherein the one-way function produces a seekable sequence of keys, the first and second sequential keys being two of the seekable sequence of keys.

5. The method of claim 1, further comprising:
generating a random root key; and
calculating the first sequential key by applying the one-way function to the random root key.

6. One or more computer-readable media storing computer-executable instructions that, when executed by one or more processors, cause the one or more processors to perform actions comprising:
providing, by a server computing system and to a client device operable by a merchant associated with a network-based accounting service, an interface enabling the merchant to record transactions in two or more journal data structures of the merchant, wherein the two or more journal data structures are managed by the network-based accounting service;
receiving, at the server computing system and via the interface, first transaction data for a first transaction of the transactions, wherein the first transaction data is to be recorded in two or more journal data entries;
adding, by the server computing system, a first journal data entry to a first journal data structure to record at least a portion of the first transaction data;
adding, by the server computing system, a second journal data entry to a second journal data structure to record at least another portion of the first transaction data, wherein the second journal data entry at least partially offsets the first journal data entry;
determining, by the server computing system, a first authentication tag to associate with the first journal data entry based at least in part on a first authentication key, wherein the first authentication key is one of a forward-secure sequence of authentication keys, wherein the first authentication tag comprises a first message authentication code determined by the server computing system based on a field of the first journal data entry and the first authentication key;
associating, by the server computing system, the first authentication tag with the first journal data entry;
receiving, by the server computing system and via the interface, second transaction data for a second transaction of the transactions, wherein the second transaction data is to be recorded in two or more additional journal data entries;
adding, by the server computing system, a third journal data entry to the first journal data structure to record at least a portion of the second transaction data, wherein the third journal data entry follows the first journal data entry in an ordered sequence of journal data entries in the first journal data structure;
determining, by the server computing system, a second authentication tag of the third journal data entry based at least in part on a second authentication key, wherein the second authentication tag comprises a second message authentication code determined by the server computing system based on a field of the third journal data entry and the second authentication key, wherein the second authentication key follows the first authentication key in the forward-secure sequence of authentication keys; and
associating, by the server computing system, the second authentication tag with the third journal data entry.

7. The one or more computer-readable media of claim 6, the actions further comprising determining the second authentication key by applying a one-way function to the first authentication key.

8. The one or more computer-readable media of claim 7, the actions further comprising:
using a random number generator to generate a root key;
determining the first authentication key by applying a one-way function to the root key; and
storing the root key.

9. (canceled)

10. The one or more computer-readable media of claim 8, the actions further comprising:
receiving a third request to verify an authenticity of the third journal data entry;
determining the second authentication key based at least in part on the root key;
calculating a third authentication tag of the third journal data entry based at least in part on determining the second authentication key; and
verifying that the third authentication tag matches the second authentication tag.

11. The one or more computer-readable media of claim 6, the actions further comprising:
receiving a third request to verify an authenticity of the second data authentication tag;
obtaining the first authentication key via an authentication manager;
recalculating, via the authentication manager, the second authentication key by applying a one-way function to the first authentication key;
calculating a third authentication tag of the third journal data entry based at least in part on recalculating calculated second authentication key; and
verifying that the third authentication tag matches the second authentication tag.

12. The one or more computer-readable media of claim 6, the actions further comprising:
receiving a request to record the first transaction, the request specifying the first transaction data and a transaction signature, the transaction signature being created with a private key of an asymmetric cryptographic key pair;
verifying the transaction signature using a public key of the asymmetric cryptographic key pair; and
adding the first journal data entry in the first journal data structure to record at least the portion of the first transaction data based at least in part on verifying the transaction signature.

13. A method performed by one or more computer servers of a network-based accounting service provider associated with creating or maintaining two or more account journals, the method comprising:
providing, to a client device operable by a merchant associated with the network-based accounting service, an interface enabling the merchant to record transactions in the two or more account journals;
receiving, via the interface, transaction requests associated with transactions to be recorded in the two or more account journals, wherein:
a first transaction request is associated with a first transaction of the transactions and is to be recorded as two or more journal entries in the two or more account journals;
a first journal entry of the two or more journal entries is to be recorded in a first account journal of the two or more account journals;
a second journal entry of the two or more journal entries is to be recorded in a second account journal of the two or more account journals;
the second journal entry offsets at least a portion of the first journal entry; and
the transaction requests are associated with an ordered sequence of journal entries;
recording the first journal entry in a first account journal of the two or more account journal s;
determining a first authentication tag of the first journal entry of the sequence of journal entries, wherein the first authentication tag comprises a message authentication code determined based on a field of the first journal entry and a first authentication key of a forward-secure sequence of authentication keys;
associating the first authentication tag with the first journal entry;
receiving, via the interface, a second transaction request of the transaction requests, wherein the second transaction request is associated with a second transaction of the transactions and is to be recorded as two or more additional journal entries in the two or more account journals;
recording a third journal entry in the first account journal, wherein the third journal entry immediately succeeds the first journal entry in an ordered sequence of journal entries in the first account journal;
determining a second authentication tag of the third journal entry based at least in part on a second authentication key of the forward-secure sequence of authentication keys, wherein the second authentication key follows the first authentication key in the forward-secure sequence of authentication keys; and
associating the second authentication tag with the third journal entry.

14. The method of claim 13, further comprising determining the second authentication key based at least in part on the first authentication key.

15. The method of claim 13, further comprising determining the forward-secure sequence of authentication keys based at least in part on a sequential key generator.

16. (canceled)

17. The method of claim 13, wherein the first journal entry is an initial journal entry of the sequence of journal entries and the first authentication key is an initial authentication key in the forward-secure sequence of authentication keys, the method further comprising:
generating a root key; and
determining the first authentication key based at least in part on the root key.

18. The method of claim 13, wherein the sequence of journal entries are recorded in response to transaction requests received from an entity other than the network-based accounting service provider.

19. The method of claim 13, wherein the first authentication key is an initial authentication key in the forward-secure sequence of authentication keys, the method further comprising:
using a random number generator to generate a root key;
determining the first authentication key by applying a one-way function to the root key; and
storing the root key.

20. The method of claim 13, wherein the forward-secure sequence of authentication keys is seekable.

21. The one or more computer-readable media of claim 6, the actions further comprising verifying an integrity of the first journal data structure based on at least one of the first authentication tag or the second authentication tag.

22. The method of claim 13, further comprising verifying an integrity of the first account journal based on at least one of the first authentication tag or the second authentication tag.
